(19) United States
(12) Patent Application Publication
(10) Pub. No.: US 2011/0289735 A1
(43) Pub. Date: Dec. 1, 2011

(54) Cord Guide Element

(76) Inventors: Antony Barnes, Stockport (GB); Andrew Greening, Elworth (GB)

(21) Appl. No.: 13/149,055

(22) Filed: May 31, 2011

(30) Foreign Application Priority Data
Jun. 1, 2010 (GB) GB1009092.6

(51) Int. Cl. F16G 11/00

(52) U.S. Cl. 24/129 R

(57) ABSTRACT

A cord guide element for a window blind cord, the element including an anchor adapted to secure the element to a blind substrate, and connected to the anchor a body which defines a cord receiving aperture, wherein the body portion is in the form of a loop and a transverse opening is defined through the loop.

The present invention relates to cord guide elements and, in particular, to cord guide elements for use in window blinds.

Many types of blinds use cord guides to guide either operating cords or lifting cords of blinds. Typically, such guides include an annular ring which defines a cord aperture and an anchor portion for securing the cord guide to the blind substrate or other part of the blind assembly.

However, it has been found that blind cords can form a choking hazard for infants and small children. Children tend to be curious about their surroundings and have been known to insert their heads into loops formed by blind cords. If they inadvertently lose their balance or slip when their head is in a loop formed by the blind cord, the blind cord can effectively become a noose for the child, resulting in serious injury, or, in the worst case, death.

Blind manufacturers have been working to reduce the risk of such injury in children.

According to a first aspect of the invention, there is provided a cord guide element for a window blind cord, the element including an anchor adapted to secure the element to a blind substrate, and connected to the anchor a body which defines a cord receiving aperture, wherein the body is substantially in the form of a loop and a transverse opening is defined through the loop by opposed end portions of the body, the opening being formed in a portion of the body which is substantially opposite the anchor and wherein the transverse opening is straight and arranged to be substantially perpendicular to the plane of the body. The loop forms the cord receiving aperture.

The skilled person will appreciate that the term “transverse opening” is intended to refer to a gap formed in the body defining the loop. In other words, the loop is discontinuous. The transverse opening is different to the aperture defined by the loop which forms the cord receiving aperture.

Thus, the cord guide of the present invention is similar to conventional cord guides, except that it includes a non-closed loop as compared with conventional cord guides which include a closed annular ring.

In other words, the present invention provides a cord guide which includes a split ring to define the cord receiving aperture.

The cord guide according to the present invention permits the cord to exit or be removed from the cord receiving aperture defined by the body via the transverse opening upon the application of at least a pre-determined minimum lateral force. In practice, this minimises or eliminates the risk of a noose being formed by the cord, as the cord is capable of being largely detached or fully detached from the blind assembly such that either no noose is formed by the cord or any noose formed is not small enough to cause significant physical injury to the child.

Accordingly, the transverse opening of the cord guide element is arranged through a portion of the cord guide body which is opposite to (i.e. distal to or furthest away from) the anchor portion.

The term “window blind” is intended to cover all blinds used in buildings and vehicles. Typically, these cover windows, but the term is intended to cover blinds used to cover any architectural opening.

The term “blind substrate” includes the element or elements of the blind assembly that controls the amount of light allowed to pass through the blind. Thus, for roller blinds, Roman blinds, cellular blinds, pleated blinds, etc. the substrate includes a sheet; and for horizontal (Venetian) blinds and other blinds which utilise a plurality of discrete components to control light transmission, the substrate includes the individual louvers or components.

The anchor may secure the cord guide element directly to the blind substrate, or the cord guide element may be secured to the substrate via an intermediate component. For example, where the blind is a Roman blind, the blind substrate comprises a sheet and secured to the sheet are a number of divisional bars (also known as horizontal bars, which function to control the drape of the sheet). In such an example, the cord guide element may be secured to the sheet via a respective divisional bar. Thus, the cord guide element may be anchored to a respective divisional bar, which in turn is secured to a blind sheet.

In normal use (i.e. in a rest position), the transverse opening may define a gap which is smaller than the diameter of the cord to prevent the cord being unintentionally removed from the cord guide(s). In its rest position, however, the two portions of the loop which define the transverse opening therebetween may contact each other to provide an opening which defines no gap. In other words, the term “gap” includes a spacing between adjacent body portions defining the opening of 0 mm.

Suitably the cord guide element is formed as a unitary or one-piece construction.

In an embodiment of the invention, the body portion defines a substantially annular loop.

The loop is planar, typically annular. In use, such a loop is arranged such that its plane is substantially perpendicular to the cord which it is intended to guide. According to the invention as defined herein, the transverse opening is arranged to be substantially perpendicular to the plane of the loop. Thus, the transverse opening may be arranged to be substantially parallel to the cord located within the loop. In such an arrangement, the cord is able to be urged through the opening upon the application of at least a pre-determined lateral force.

In order to define a straight exit for the guide cord from the cord guide element and remove any risk of the guide cord being snagged on a part of the cord guide element, the transverse opening defines a straight exit path from the cord receiving aperture defined by the body. Thus, the opposite end portions of the body suitably do not overlap each other in any way. They may be arranged such that the end portions of the body are in an abutting relationship or are located adjacent to each other. However, the end portions of the body do not overlie or overlap with any portion of the body.

Suitably, the transverse opening (i.e. the exit path) is formed radially with respect to an axis through the loop. Thus, where the loop is annular, the axis though the loop is a longitudinal axis which passes through the centre of the annulus. Accordingly, an embodiment of the invention provides a transverse opening which is defined by a straight radial gap or channel in the body of the cord guide element.

The body portion of the cord guide element may be resiliently deformable such that the two end portions of the body between which the transverse opening is defined may be biased towards each other. As mentioned above, this may result in a zero gap defined by the opening and would reduce the likelihood of the cord becoming unintentionally detached from the cord guide element.

In an embodiment of the invention as defined anywhere herein, the opening is adapted to define a minimum gap upon the application of a predetermined lateral force. The minimum gap is typically equal to or greater than the diameter of the cord. Thus, upon application of the pre-determined lateral force, the gap defined by the opposing end portions of the body will increase to permit the cord to pass therethrough. The pre-determined lateral force is typically greater than would be encountered in normal use of the blind, but less than would be exerted by a child trapped in the cord.

In this embodiment, the cord guide(s) will function normally all the time there is no excessive lateral force applied to the cord(s). This is because any lateral forces encountered by the cord guides in normal use will be less than the pre-determined lateral force limit. However, a struggling child caught in the blind cord will exert significantly more lateral force that the pre-determined limit, which would have the effect of increasing the gap defined by the transverse opening such that it permits the cord to pass therethrough and out of engagement with the cord receiving loop of the cord guide element. In other words, a lateral force greater than the per-determined limit will urge the guide cord to exit the cord guide element via the transverse opening. With the cord removed from the cord guide element(s), the risk of injury to the child is greatly minimised.

In a further embodiment of the invention, the cord guide element is a Roman blind cord guide element. In this embodiment, the anchor is adapted to secure the element to a divisional or horizontal bar, which in turn is secured to the Roman blind sheet. The divisional bar may include a longitudinal channel, wherein the anchor includes at least one cam surface adapted to secure the anchor within the channel. Suitably, the channel includes opposed walls and the anchor includes a pair of opposed cam surfaces such that in a first orientation, the anchor can slide within the channel and in a second orientation, the opposed cam surfaces engage the opposed channel walls and prevent movement of the anchor relative to the channel.

According to a second aspect of the invention, there is provided a blind including a substrate, a cord and at least one cord guide element as defined anywhere hereinabove, wherein the at least one cord guide element is secured to the substrate via the anchor portion and the cord passes through the loop defined by the body of the or each cord guide element.

Blinds typically include more than one cord. In such embodiments, the blind may include a plurality of arrays of cord guide elements, where the number of arrays equals the number of cords. As the cords are normally arranged vertically in use, the arrays of cord elements may be arranged vertically.

The skilled person will appreciate that the term “array” is intended to mean a group of cord guide elements having a specific geometric arrangement. Suitably, the arrangement is a straight line and the cord guide elements are arranged such that the planes of their respective loops are parallel.

In an embodiment of the invention, the transverse opening includes a gap defined by the opposed end portions of the body which in its rest position is smaller than the diameter of the cord, and the and the body is resiliently deformable such that upon the application of a pre-determined lateral force by the cord on the body, the gap increases until it is equal to or greater than the diameter of the cord, whereby the cord is capable of being urged out of the loop defined by the body.

The skilled person will appreciate that the features described and defined in connection with the aspect of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

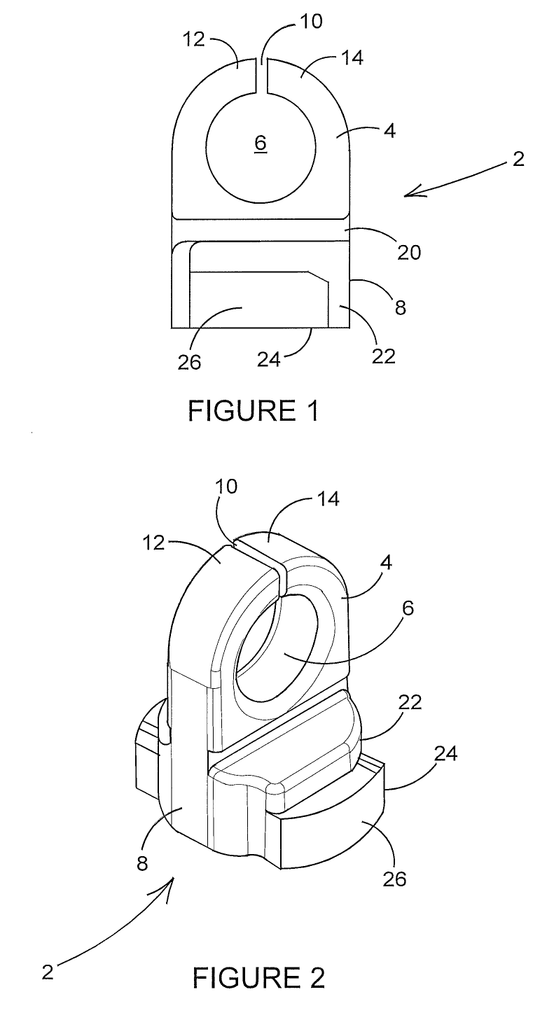

FIG. 1 is an elevational view of a cord guide element according to the present invention;

FIG. 2 is a perspective view of the cord guide element of FIG. 1;

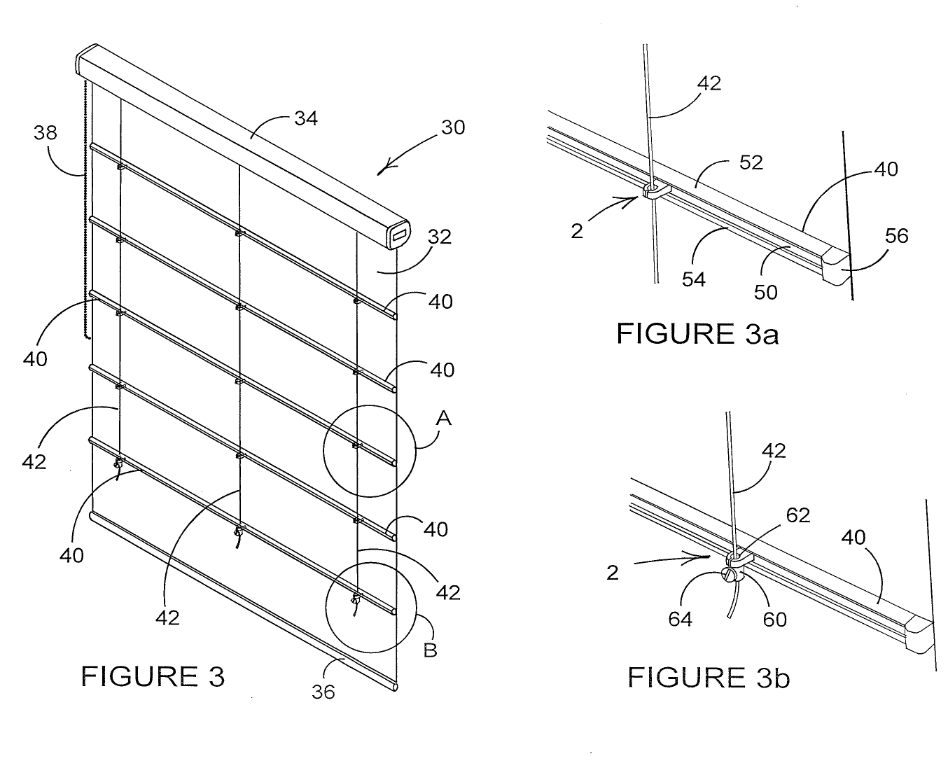

FIG. 3 is perspective view of a Roman blind arrangement including arrays of cord guide elements as shown in FIGS. 1 and 2;

FIG. 3a is an enlarged view of the area A of FIG. 3; and

FIG. 3b is an enlarged view of the area B of FIG. 3.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIGS. 1 and 2 shows a cord guide element 2 according to the invention. The cord guide element 2 includes a substantially annular body 4 which defines an aperture 6. The aperture 6 functions as a cord receiving aperture, as will be seen below. The cord guide element also includes an anchor 8.

The cord guide element 2 is a one-piece injection moulded polymeric component.

The body 4 defines a transverse opening 10 between opposed body portions 12, 14. The opening 10 has a width of 0.5 mm. In other words, the spacing between the body portions 12, 14 is 0.5 mm.

The anchor 8 is connected to the body 4 via a neck portion 20. Each side of the neck portion 20 projects outwardly to form opposed shoulders 22. The distal end portions of the shoulders 22 define cam portions 24 each having a cam surface 26.

FIG. 3 shows a Roman blind 30 from the rear (i.e. the side which faces the window in normal use and which is not seen from inside the room).

The Roman blind 30 includes a sheet 32 of fabric material located between a headrail 34 and a bottom bar 36. The fabric is raised and lowered via an operating chain 38 and a plurality (in this embodiment, 5) of horizontal divisional bars 40 are secured to the sheet 32 at vertical intervals, such that the vertical spacing between the divisional bars 40 is substantially equal. The skilled person will recognise the foregoing as a description of a known Roman blind arrangement.

Three lifting cords 42 are provided to raise the sheet 32 in response to rotation of the operating chain 38 and to control the lowering of the sheet 32 when the operating chain 38 is rotated in the opposite sense. The lifting cords 42 are secured to the bottom divisional bar 40 and are guided by cord guide elements 2 carried by alternate divisional bars 40. Thus, the top, middle and bottom divisional bars 40 each carry three cord guide elements 2 arranged to be adjacent to a respective lifting cord.

The lifting cords 42 have a diameter of 1 mm, i.e. greater than the opening 10 defined by the body 4.

The cord guide elements are all arranged such that the plane of the body 4 is arranged to be horizontal and the lifting cords 42 pass through the cord receiving apertures 6 of the respective cord guide elements 2.

With regard to the cord guide elements carried by the bottom divisional bar 40, the respective lifting cords 42 are secured to these via a stop element 60 (shown in more detail in FIG. 3b) fixed to the cord 42 and which is sized such that it is not able to pass through the cord receiving aperture 6. Thus, the stop elements 60 secure the lifting cords 42 to the bottom divisional bar 40.

FIG. 3a is an enlarged view of the portion A of FIG. 3. FIG. 3a shows the middle divisional bar 40 in more detail. Each of the divisional bars 40 is identical.

The divisional bar 40 defines a longitudinally open channel 50 between a top wall 52 and a bottom wall 56. The outwardly facing end portions of top and bottom walls are both turned inwards to define inwardly projecting lips. The channel is closed at each end by an end cap 56 (only one of which is shown in FIG. 3a).

FIG. 3b shows the stop element 60 in more detail. The stop element 60 includes a substantially cylindrical body through which the lifting cord 42 passes. A top portion 62 of the stop element 60 engages the body 4 of the cord guide element 2 and prevents the stop element 60 from passing through the cord receiving aperture 6. A clamp screw 64 extends into the central bore of the stop element 60 and clamps the lifting cord 42 between the distal end of the clamp screw 64 and the internal wall of the stop element 60 which is opposite the threaded bore that carries the clamp screw 64. In this arrangement, the stop element 60 is positioned at the desired position relative to the lifting cord 42 and then secured relative to the lifting cord 42 by tightening the clamp screw 64.

To assemble the blind 30, the fabric sheet 32 and the lifting cords are secured to the headrail 34 in the usual way and the bottom bar 36 is inserted into a pocket formed at the bottom of the blind sheet 32. The divisional bars are secured to the sheet such that the channel 50 faces rearwards. There are numerous different ways of securing divisional bars to fabric sheets which are known to persons skilled in the art of Roman blinds, for example, see FIG. 7 of U.S. 2004/0231805. As such, a detailed description of this is not provided herein.

The cord guide elements 2 are then secured to the top, middle and bottom divisional bars 40 via their anchors 8. More specifically, each cord guide element 2 is arranged with the body 4 in a vertical plane and the shoulders 22 and cam portions 24 projecting horizontally. In this orientation, the anchor 8 can be inserted into the channel 50 defined by the divisional bar 40, as the diameter of the body 4 is less than the width of the channel 50 (i.e. the gap defined between the top wall 52 and the bottom wall 54). Once the anchor 8 is located within the channel 50, the cord guide element 2 is rotated through 90° until the plane of the body 4 is horizontal. In rotating the anchor through 90°, the cam surfaces 26 engage the top and bottom walls 52, 54 and prevent movement of the cord guide element 2 relative to the divisional bar 40. The lips formed by the inwardly turned end portions of the top and bottom walls 52, 54 prevent the removal of the anchor 8 from the channel 50 in a transverse direction relative to the longitudinal axis of the channel 50.

Once all of the cord guide elements 2 are in the correct location and form a 3×3 array on the rear surface of the blind sheet 32, the cords 42 are located within the cord receiving apertures 6. At the point where the lifting cords 42 exit the cord guide elements 2 carried by the bottom divisional bar 40, the stop elements 60 are fixed to the cords 42 via their respective clamp screws 64. The top portion 62 of the stop elements 60 are not able to pass through the cord receiving aperture 6 and effectively secure the cords 42 to the bottom divisional bar 40.

As the lifting cords 42 have a greater diameter than the opening 10 defined by the body 4, the lifting cords 42 are retained within the cord receiving aperture 6 in normal use.

In the event that a child gets his or her head stuck between one of the lifting cords 42 and the blind sheet 32 and slips or loses his or her balance, the lateral force exerted on the lifting cord 42 away from the blind sheet 32 will urge apart the opposed body portions 12, 14. This in turn will increase the width of the opening 10 and permit the cord 42 to exit the cord guide element 2. As the cord 42 is secured to the sheet 32 at all points via cord guide elements 2, the cord 42 is able to entirely separate from the sheet 32. This prevents a loop or noose from being formed and removes the risk of strangulation or serious injury to the child.

1. A cord guide element for a window blind cord, the element including an anchor adapted to secure the element to a blind substrate, and connected to the anchor a body which defines a cord receiving aperture, wherein the body portion is substantially in the form of a loop and a transverse opening is defined through the loop by opposed end portions of the body, the opening being formed in a portion of the body which is substantially opposite the anchor and wherein the transverse opening is straight and arranged to be substantially perpendicular to the plane of the body.

2. A cord guide element according to claim 1, wherein the body defines a substantially annular loop.

3. A cord guide element according to claim 1, wherein the two end portions of the body between which the transverse opening is defined are biased towards each other.

4. A cord guide element according to claim 1, wherein the body is adapted to define a minimum opening upon the application of a pre-determined lateral force.

5. A blind including a substrate, a cord and at least one cord guide element according to claim 1, wherein the at least one cord guide element is secured to the substrate via the anchor and the cord passes through the loop defined by the body of the or each cord guide element.

6. A blind according to claim 5, wherein the transverse opening defined by the body in its rest position has a width which is smaller than the diameter of the cord, and the body is resiliently deformable such that upon the application of a predetermined lateral force by the cord on the body, the transverse opening increases to have a width which is equal to or greater than the diameter of the cord, whereby the cord is capable of being urged out of the loop of the cord guide element upon the application of the pre-determined lateral force.
